(19) United States
(12) Patent Application Publication
(10) Pub. No.: US 2025/0144938 A1
(43) Pub. Date: May 8, 2025

(54) INK JET PRINT HEAD WITH MIST REMOVING SYSTEM

(71) Applicant: Canon Production Printing Holding B.V., Venlo (NL)

(72) Inventors: Roy H.R. JACOBS, Venlo (NL); Mahnaz SHOKRPOUR ROUDBARI, Venlo (NL)

(73) Assignee: Canon Production Printing Holding B.V., Venlo (NL)

(21) Appl. No.: 19/013,751

(22) Filed: Jan. 8, 2025

Related U.S. Application Data
(63) Continuation of application No. PCT/EP2023/069331, filed on Jul. 12, 2023.

(30) Foreign Application Priority Data
Jul. 21, 2022 (EP) 22186161.0

(51) Int. Cl. B41J 2/17; B41J 29/377

(52) U.S. Cl. CPC B41J 2/1714; B41J 29/377

(57) ABSTRACT

An ink jet print head having a nozzle face arranged to form a gap with surface of a media conveyor, an air duct and a suction blower arranged to withdraw air from said gap, and an array of electrodes arranged to create an inhomogeneous electric field for attracting droplets of an ink mist, wherein the array of electrodes is arranged within the air duct.

The invention relates to an ink jet print head having a nozzle face arranged to form a gap with a surface of a media conveyor, an air duct and a suction blower arranged to withdraw air from said gap, and an array of electrodes arranged to create an inhomogeneous electric field for attracting droplets of an ink mist.

A print head of this type has been disclosed in US 2008225080 A1. The air duct and the blower are provided for removing a mist of liquid ink that is formed in the gap when ink droplets impinge on the surface of the media. The air duct contains a filter for separating the mist droplets from the air in order to prevent air pollution in the environment of the printer. Further, the printer has a curing lamp that is facing the surface of the media conveyor and is disposed immediately downstream of the nozzle face. The electrodes are arranged on opposite sides of the curing lamp in order to attract ink droplets that would otherwise contaminate the curing lamp.

It is an object of the invention to facilitate maintenance of the mist removing system.

In order to achieve this object, a print head according to the invention is characterized by the feature that said array of electrodes is arranged within the air duct.

In the print head according to the invention, the electrodes have the function to separate the mist droplets from the air that is withdrawn through the air duct. A filter for removing residual mist may still be provided in the air duct downstream of the array of electrodes, but since a major part of the mist droplets has already been removed by means of the electrodes, the rate at which the filter becomes clogged is reduced significantly, so that the maintenance intervals can be extended. The liquid ink that has been attracted to the electrodes can easily be removed from time to time, e.g. by means of a wiper, so that the maintenance of the mist removing system is facilitated.

More specific optional features of the invention are indicated in the dependent claims.

The array of electrodes may be an alternating array of positive and negative electrodes that are embedded in an electrically insulating electrode plate at least one surface of which is exposed to the current of air and mist in the air duct.

In one embodiment, at least two electrode plates are arranged opposite to one another to delimit a flow path for the air and mist.

In order to increase the likelihood that mist droplets come close enough to the surface of the electrode plate to be attracted thereby, the electrode plates may be arranged to form a labyrinth. For example, the electrode plates may form two interleaved comb-like structures that project from opposite walls of the air duct, forcing the air to flow through the duct in a meandering flow pattern. The walls of the air duct that carry the comb-like structures of electrode plates are preferably detachable from the rest of the air duct, so that the electrode plates can easily be accessed for cleaning purposes.

The air duct may have an inlet for ambient air formed downstream of the gap but upstream of the electrode plates, so that the mist-loaded air that is withdrawn from the gap is diluted with ambient air before passing the electrode plates. The ambient air inlet may also be utilized for controlling the volume of air that is withdrawn from the gap and, therewith, the flow velocity of the air within the gap.

Embodiment examples will now be described in conjunction with the drawings, wherein:

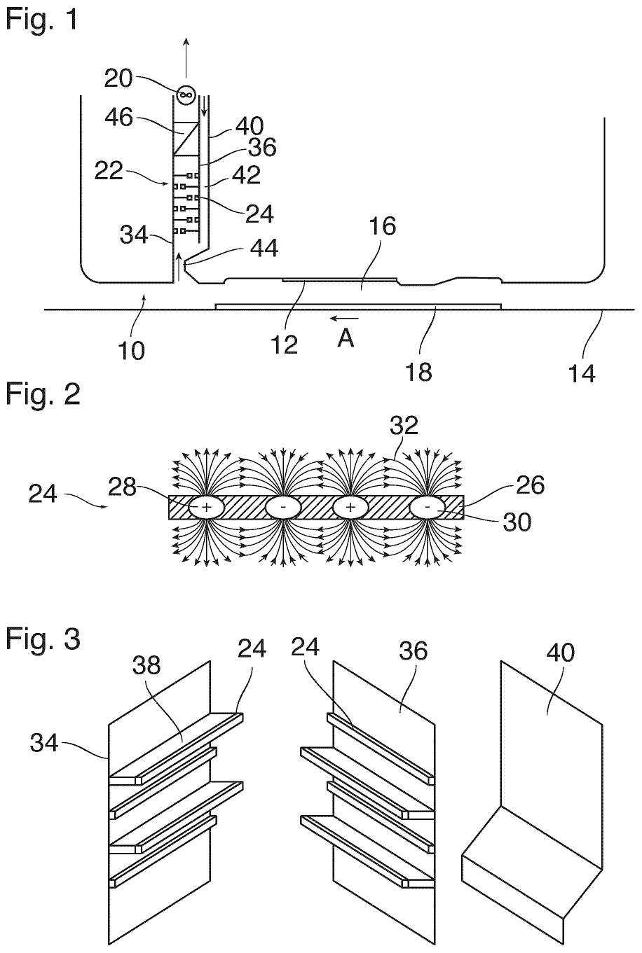

FIG. 1 is a schematic side view of a print head according to the invention;

FIG. 2 is an enlarged sectional view of a part of an electrode plate and also shows an electric field created by the electrodes;

FIG. 3 is an exploded perspective view of an assembly forming an air duct within the print head shown in FIG. 1;

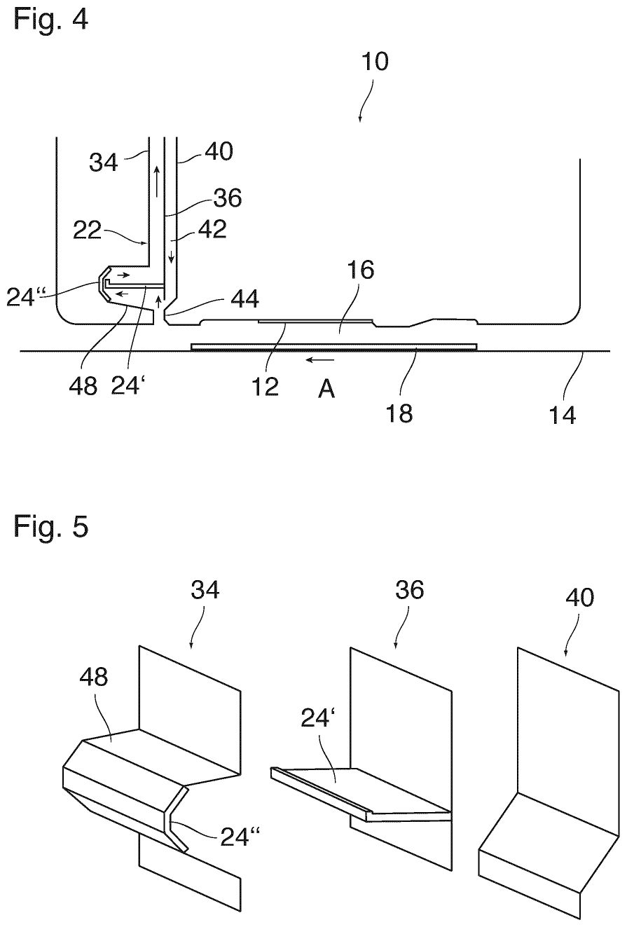

FIG. 4 is a schematic side view of a print head according to another embodiment of the invention; and

FIG. 5 is an exploded perspective view of an air duct assembly in the print head shown in FIG. 4.

As is shown in FIG. 1, a print head 10 has a nozzle face 12 arranged above a surface of a media conveyor 14, so that a gap 16 is formed between the nozzle face and the media conveyor. The media conveyor 14 may for example be formed by an endless belt and serves for moving media sheets 18 past the nozzle face 12 in a direction designated by an arrow A, so that an image may be printed onto the media sheet by ejecting ink droplets from nozzles formed in the nozzle face 12. As is well known in the art, the nozzle face 12 may be a surface of a chip that integrates a large number of piezoelectric ink ejection units.

When the ink droplets jetted out from the nozzles of the print head 10 impinge on the surface of the media sheet 18, minute droplets of ink may rebounce from the media sheet so that, depending upon the physical properties of the ink and the surface of the media sheet, a mist of liquid ink is formed in the gap 16. Due to the movement of the media conveyor 14 and the media sheets 18, the air in the gap 16 will be entrained in the direction of the arrow A, so that the mist is spread into the environment and may cause air pollution and/or contaminate other parts of the printing system.

In order to prevent the mist from escaping from the gap 16 into the environment, a suction blower 20 and an air duct 22 are provided inside the print head 10 and arranged to withdraw air from the gap 16 near the downstream end of the gap. In the example shown, the air duct 22 branches off from the gap 16 at right angles. It will be understood that the air duct 22 will extend over the entire width of the nozzle face 16 in the direction normal to the plane of the drawing in FIG. 1.

The flow rate of the air in the air duct 22 may be controlled such that the flow of air that is created in the gap 16 by the movement of the media conveyor and the media is almost totally diverted into the air duct 22 so that practically no air current on even a countercurrent of air is present in the end of the duct 16 located beyond of the air duct 22 on the left side in FIG. 1. On the other hand, the flow rate in the air duct 22 will not significantly increase the air current that is flowing past the nozzle face 12, so that the air current along the nozzle face is not significantly larger than the current that would be induced by the movement of the media conveyor and the media, anyway. Consequently, the flow velocity of the air is so small that it will not cause substantial aberration of the ink droplets that are jetted out from the nozzles.

The air duct 22 contains a labyrinth that is at least partly formed by electrode plates 24.

As is shown in FIG. 2, each electrode plate 24 is constituted by an electrically insulating plate 26 into which an array of alternating positive electrodes 28 and negative electrodes 30 has been embedded. The electrodes 28, 30 extend in parallel, e.g. in a direction transverse to the flow direction of air in the air duct 22. A voltage difference of, e.g., 350 V exists between the positive and negative electrodes, so that the electrodes generate an inhomogeneous electric field 32, as has been shown symbolically in FIG. 2.

If the mist droplets carried along in the air current in the air duct 22 have a negative charge, they will be attracted by the positive electrodes 28, and if they have a positive charge, they will be attracted by the negative electrodes 30. If the droplets do not carry an electric charge, they will nevertheless be attracted to one of the electrodes because of the inhomogeneity of the electric field 32.

As can be seen more clearly in FIG. 3, the electrode plates 24 are mounted onto parallel vertical plates 34, 36 which constitute side walls of the air duct 22. On each plate 34, 36, every second electrode plate 24 is formed along the edge of a ledge 38 whereas the other half of the electrode plates is attached directly to the vertical plate 34 and 36, respectively. Thus, the electrode plates 24 and ledges 38 form two interleaved comb-like structures forming the labyrinth through which the air current is forced to flow in a meandering flow pattern. This increases the likelihood that almost all ink droplets will be attracted to and collected at one of the electrode plates 24.

The vertical plate 36 and another essentially vertical plate 40 delimit an intake duct 42 (FIG. 1) for ambient air that opens out into the air duct 22 in a position below (upstream of) the labyrinth of electrode plates 24. The lower end of the plate 40 is angled towards the plate 34, so that both plates together form a throttle 44 limiting the flow of air from the gap 16 into the air duct 22. This has the effect that an underpressure is created above (downstream of) the throttle 44, so that ambient air is drawn in through the intake duct 42. In this way, the flow velocity of the air in the air duct 22 can be increased without withdrawing too much air from the gap 16. The increased flow velocity may cause a turbulent flow of air in the labyrinths, so that the mist droplets can be collected by the electrode plates 24 more efficiently. Moreover, the air drawn in through the intake duct 42 permits to operate the blower 20 at a higher speed, so that the amount of air withdrawn from the gap 16 via the throttle 44 can be controlled more precisely.

A filter 46 is provided in the air duct 22 between the labyrinth of the electrode plates 24 and the suction blower 20. The purpose of this filter 46 is to hold back any residual mist droplets that may have escaped the electrode plates 24. Since the amount of ink that remains to be filtered-out in the filter 46 is only very small, the filter can operate for a large operation time without having to be regenerated. This reduces maintenance work as well as costs for the filter material.

Although not shown in the drawing, the vertical plates 34, 36 and 40 are detachably mounted in the print head 10. When these plates have been detached, the electrode plates 24 are easily accessible, as is shown in FIG. 3, and the ink collected at the electrode plates 24 can easily be wiped-off with a wiper. In this way, the maintenance work required for the mist removing system is facilitated.

FIGS. 4 and 5 illustrate a modified embodiment which differs from the embodiment shown in FIGS. 1 to 3 in that an electrode plate 24′ is configured as a baffle that projects from the vertical wall 36 into a depression 48 formed in the opposite wall 34. Another electrode plate 24″ forms a lining in the bottom of the depression 48. Again, the electrode plates 24′ and 24″ constitute a labyrinth for effectively collecting the mist entering through the throttle 44.

1. An ink jet print head having a nozzle face arranged form a gap with surface of a media conveyor, an air duct and a suction blower arranged to withdraw air from said gap, and an array of electrodes arranged to create an inhomogeneous electric field for attracting droplets of an ink mist, wherein said array of electrodes is arranged within the air duct.

2. The print head according to claim 1, wherein said array of electrodes comprises at least one electrode plate constituted by an electrically insulating plate with the electrodes embedded therein.

3. The print head according to claim 2, wherein the electrodes extend in parallel to one another.

4. The print head according to claim 2, wherein at least two electrode plates constitute a labyrinth causing the air flow in the air duct to meander.

5. The print head according to claim 4, wherein the electrode plates are formed on parallel plates that constitute side walls of the air duct.

6. The print head according to claim 5, wherein the electrode plates form two interleaved comb-like structures.

7. The print head according to claim 1, wherein the air duct is narrowed to form a throttle at a position upstream of the array of electrodes, and an intake duct for ambient air enters into the air duct at a position downstream of the throttle and upstream of the array of electrodes.

8. The print head according to claim 1, wherein a filter is provided in the air duct downstream of the array of electrodes.
